(19) United States
(12) Patent Application Publication
(10) Pub. No.: US 2008/0078944 A1
(43) Pub. Date: Apr. 3, 2008

(54) COMPUTER CONTROLLED ACTIVE FEEDBACK SYSTEM FOR LDI/ES ION SOURCE WITH ELECTRO-PNEUMATIC SUPERPOSITION

(76) Inventor: Andreas Hieke, Cupertino, CA (US)

Correspondence Address: GREENBERG TRAURIG LLP;ATTN: IP DOCKETING DEPT, Suite 400 East, 2450 Colorado Avenue, Santa Monica, CA, 90404, US

(21) Appl. No.: 11/852,087

(22) Filed: Sep. 7, 2007

Related U.S. Application Data
(60) Provisional application No. 60/843,205, filed on Sep. 7, 2006.

(51) Int. Cl. H01J 3/14

(52) U.S. Cl. 250/400

(57) ABSTRACT

This invention relates to systems and methods of optimizing the control and performance of Laser Desorption and Ionization (LDI) ion sources or Electro Spray (ES) ion sources employing electro-pneumatic superposition, the ion sources being operably connected to a mass spectrometer. Methods and systems of control include analyzing data from the mass spectrometer during its operation, generating signals from the data analysis, and providing the signals as feedback to control the operation of the ion source. Data from which informative feedback signals are generated may include the mass spectrum data from a sample being analyzed, and may also include data from sensors providing conditions of the ion source during operation.

### CROSS-REFERENCE TO RELATED APPLICATIONS

The following applications are related to this application: “Ion source with controlled superposition of electrostatic and gas flow fields” (U.S. App. 11/063,485, filed on Feb. 22, 2005), “Methods and apparatus for controlling ion current in an ion transmission device” (U.S. application Ser. No. 11/063,801 filed on Feb. 22, 2005), “Laser desorption ionization ion source with charge injection” (U.S. App. 60/798,377, filed on May 5, 2006), and “Laser desorption ionization ion source with self-adjusting holder and insertion system for one and two-dimensional sample chips” (U.S. App 60/802,941, filed on May 23, 2006). This application is further related to two U.S. Provisional Patent Applications being filed concurrently with this one, the applications entitled “Advanced ion source for macromolecules” and “Ion source with controlled liquid injection,” respectively.

### FIELD OF THE INVENTION

The present invention relates to systems and methods for optimizing the control of an ion source utilizing electro-pneumatic superposition connected to a mass spectrometer by feedback from operational data.

### BACKGROUND

Laser Desorption Ionization (LDI) and Electrospray (ES) ion sources have become an essential and component in the modern mass spectrometry of biological macromolecules (e.g. proteins, peptides, and sugars). Both methods revolutionized the application of mass spectrometers in life science, in particular in proteomics but also in functional genomics and metabolomics and drug discovery.

In Matrix Assisted Laser Desorption and Ionization (MALDI) ion sources, typically a UV laser (sometimes IR) are fired at the crystals in the MALDI spot with typical pulse duration on the order of t_{LP}≈10⁻⁹ to 10⁻⁸ s. The matrix molecules in the spot absorb the electromagnetic laser energy. It is generally thought that the matrix is ionized by this event, and then transfers part of its charge to the analyte molecules (e.g. a protein), thus ionizing them while still protecting them from the disruptive energy of the laser.

One variant of MALDI is sometimes referred to as Surface Enhanced Laser Desorption Ionization (SELDI) in which the matrix is already pre-deposited on the target surface (“MALDI” will refer to both MALDI and SELDI). Originally, LDI/MALDI ion sources were operated under vacuum conditions at pressures where sample ion-background gas collisions are negligible. Later, ion sources operating at elevated pressure and Atmospheric Pressure MALDI (AP MALDI) were introduced for their convenience in terms of sample handling, as well as collisional cooling.

Experiments carried out in the early 90's indicated improved ion transmission within gas-filled multiple ion guides due to “collisional cooling”: Repeated collisions of ions with gas molecules reduce the temperature of the ions and also cause the ion beam to collapse axially inside RF multiple ion guides (D. J. Douglas and J. B. French: “Collisional focusing effects in radiofrequency quadrupoles,” J. Am. Soc. Mass Spectrometry 1992, no. 3, p. 398-408). This collisional cooling effect was subsequently utilized in MALDI ion sources themselves. Simple versions of so called elevated pressure and Atmospheric Pressure MALDI (AP MALDI) ion sources have been described, beginning in the late 1990's. However, their ion-optical design is not completely satisfactory, and a pneumatic design is effectively non-existent due to the lack of appropriate computational design tools capable of modeling the flow field as well as the electro-pneumatic interactions (ion-neutral collisions).

In advanced implementations of the second major ionization method for biological macromolecules, electrospray, electric-pneumatic superposition is equally important. In electrospray ion sources, a liquid in which the sample molecules are dissolved is pressed through a capillary. The sample molecules are already in an ionized state inside the liquid. Upon leaving the capillary, through a nebulization process, the liquid forms a mist (or aerosol) of very small droplets containing ionized sample molecules. Due to coulombic forces, individual ionized sample molecules are eventually released and transported into a mass spectrometer, although the exact mechanism of the ion formation is under debate. However, since the entire process typically occurs in the presence of a gas or, more generally, a gas flow field as well as an electric field, advanced configurations with electro-pneumatic superposition provide distinct advantages. One reason for using gas flow fields and electro-pneumatic superposition, however, is to support nebulization and ion guidance. In addition, controlled moderate collisional heating may be affected.

Due to high laser power densities LDI creates ions with substantial translational and internal temperatures that frequently results in fragmentation and decay that generates molecular fragments, thereby limiting the available ion life time for analysis. It is, therefore, advantageous to employ collisional sample ion cooling by means of intentionally introduced gases. In advanced types of such collisionally-cooled LDI ion sources the actual ion dynamics are the result of so-called electro-pneumatic superposition, which picks utilizes electro-pneumatic elements to create specifically designed electric fields as well as gas flow fields.

Analogously, ES ion sources, which create ions from a liquid by means of high electric fields, typically operate at atmospheric gas pressures or at least at elevated pressures. Again, the use of electro-pneumatic superposition by means of electro-pneumatic elements to create specifically designed electric fields as well as gas flow fields provides significant advantages with respect to ion guidance and introduction in a mass spectrometer with minimal losses.

In both applications the optimal superposition and the resulting ion dynamics will depend on various operational parameters, such as sample composition, sample spot surface chemistry (in case of MALDI), physical and chemical properties of the liquid (in case of ES). Such varied conditions may cause the optimal point of operation of the ion source to shift (within its parameter space); more particularly, changes in gas supply and electric field strength may be required.

Due to the complexity of the ion source behavior, the number of parameters that can be adjusted, and the limited available time, a typical user of such ion sources (connected mass spectrometers) cannot be expected to perform such correcting adjustments in an optimal and rapid fashion. Accordingly, Improvements in systems that offer active control and feedback of operating parameters would be desirable.

### SUMMARY OF THE INVENTION

Embodiments of this invention relate to systems and methods that optimize the control of ion sources employing electro-pneumatic superposition, the ion sources being operably connected to a mass spectrometer. Methods and systems of control include collecting and analyzing data from the mass spectrometer during its operation, generating signals from the data analysis, and providing the signals as feedback to control various aspects of the operation of the ion source. Data from which informative feedback signals are generated may include the mass spectrum data from a sample being analyzed, and may also include data from sensors reporting conditions from the locale of the ion source, as well as data from other sources.

The ion source of mass spectrometers controlled by embodiments of these systems and methods may include ion sources of the laser desorption ionization type as well as the electrospray type. Some embodiments of the ion source may make use of charge injection (CI-LDI/CI-MALDI), and may further make use of two-dimensional sample chips.

Objectives of the optimization of the control of the ion source include optimally guiding ions, cooling ions collisionally, and optimally guiding droplets containing sample ions. Optimizing control may be effected by various approaches, for example, by changing the multiplicity of the gas reservoir pressures used to supply gas to the ion source region in which the electro-pneumatic superposition occurs, or by controlling changing the total gas flow to the ion source region in which the electro-pneumatic superposition occurs. Optimizing control may further be effected by changing the electric potentials on electro-pneumatic elements.

Optimizing control may further be effected by changing the mechanical arrangement of electro-pneumatic elements such as angles or gap-width by means of active drives such as stepper motors. Optimizing control may still further be effected by changing the timing behavior of the electric or pneumatic parameters. Optimizing control may even still further be effected by changing the operation of a pump connected to the ion source or the gas flow to said pump by means of a throttling valve.

Embodiments of the presently described active control system may assume various configurations, for example, they may be integrated into the control system of the ion source, they may be integrated in the control system of the mass spectrometer, or they may be stand-alone devices.

Embodiments of the active control system may make use of information obtained throughout the entire mass spectrometric data acquisition process to provide feedback information to optimize the performance of the ion source, or they may make use only of information obtained during an initial phase of the mass spectrometric data acquisition process. In these embodiments, the active control system is providing feedback in real time. In other embodiments of the active controls or it may make use of stored information, such stored information may also be encoded in the sample itself or on a bio-chip.

Embodiments of the active control system make use of an algorithm that derives variously from any of the control signals provided to the ion source from the total ion count, from the signal to noise ratio in the mass spectrum, and/or from the amount of fragment or cluster ions in the mass spectrum.

### BRIEF DESCRIPTION OF THE DRAWINGS

FIG. 1 is a simplified schematic 3D overview of the electro-pneumatic elements in a LDI ion source with controlled electro-pneumatic superposition. The tips of a RF quadrupole ion guide are visible.

FIG. 2 is a numerical solution of gas pressure (top) and gas flow velocity magnitude (bottom) for configuration depicted for the configuration shown in FIG. 1 at one particular operational point.

FIG. 3 is a simplified schematic overview of a LDI ion source with controlled electro-pneumatic superposition connected to a triple-quad time-of-flight (TOF) mass spectrometer.

FIG. 4 is a typical mass spectrum obtained from an electro-pneumatic LDI ion source for a single labile compound as test sample at different operational points (gas reservoir pressures).

FIG. 5 is a numerical solution of gas flow velocity magnitude (left) resulting ion trajectories (right) for two operational points (gas reservoir pressure and inlet distribution) for an electro-pneumatic LDI ion source (top vs. bottom) exhibiting ion losses at the operational point shown at the top.

FIG. 6 is a principle design ion source with an active control and feedback system. A plurality of digital and/or analog inputs and outputs, such as variable voltage sources, enable a control computer to keep the ion source at optimal operational conditions.

FIG. 7 is a simplified design a LDI ion source with an active control and feedback system and additionally employing controlled charge injection (CI-LDI/CI-MALDI) by means of a separate the ion beam gun connected to a high-end triple-quadrupole-Time-of-Flight (TOF) instrument

### DETAILED DESCRIPTION OF THE INVENTION

The subsequently described embodiments of an active feedback and control system for ion sources and applies to both LDI and ES technology in conjunction with electro-pneumatic superposition. The following patent applications of Hieke are related to the presently described embodiments of the invention, and are included by this reference: “Ion source with controlled superposition of electrostatic and gas flow fields” (WO05081944A2 and US2005194542A1, both filed on Feb. 22, 2005); and “Methods and apparatus for controlling ion current in an ion transmission device” (US2005194543A1 and WO05081916A2, both filed on Feb. 22, 2005). Provisional U.S. applications that are related and included by this reference are “Laser desorption ionization ion source with charge injection” (U.S. App. No. 60/798,377, filed on May 5, 2006) and “Laser desorption ionization ion source with self-adjusting holder and insertion system for one and two-dimensional sample chips” (U.S. App. No. 60/802,941, filed on May 23, 2006.

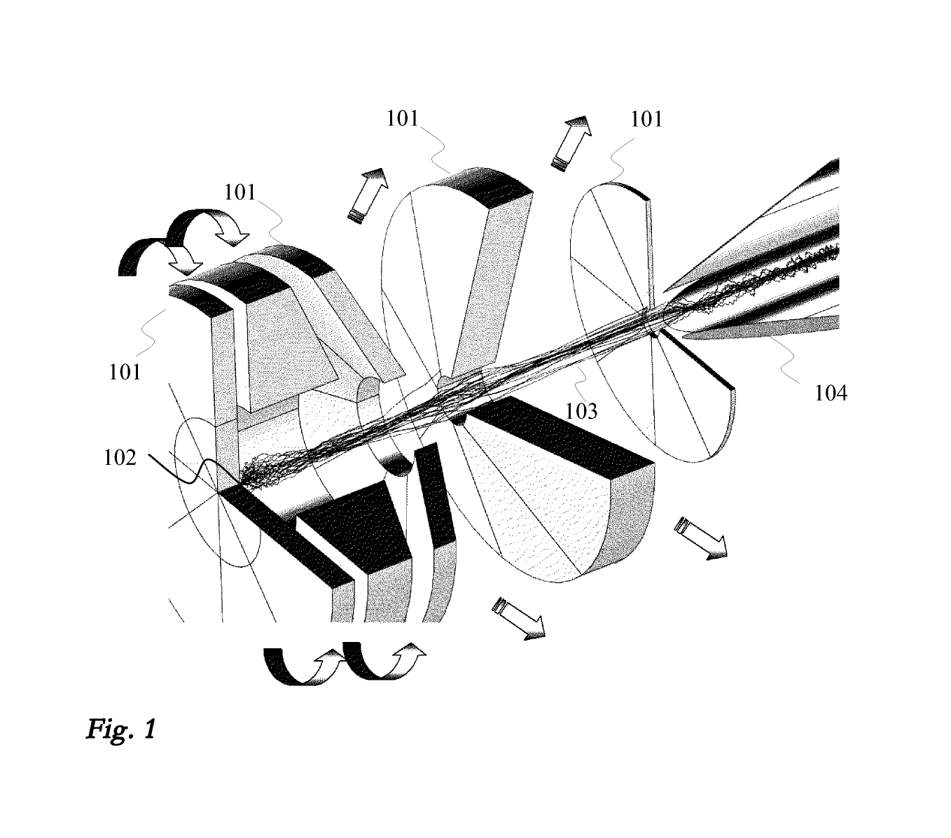

As illustrated in FIG. 1 the functionality of advanced ion sources employing electro-pneumatic superposition, per aspects of this invention, depends on shape and arrangement of a number of so-called electro-pneumatic elements 101. The sample ions originate from a small spatial area, typically a sample spot, 102 and form a continuous or pulsed beam 103 which is, in this example, injected in a RF quadrupole ion guide 104. Gas flows through this structure as indicated by the arrows.

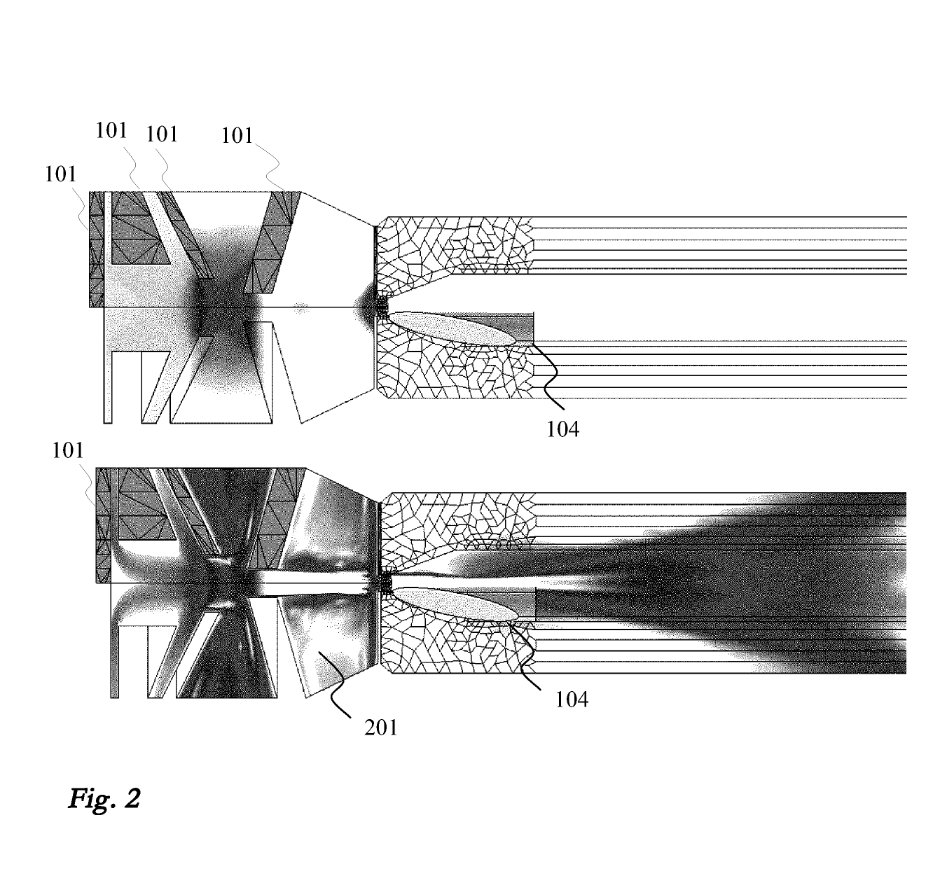

To understand the operation of such ion sources, per aspects of this invention, the visualization of the electric fields and pneumatic flow fields created by the electric-pneumatic elements and the computation of ion trajectories are helpful. FIG. 2 shows one such example. The numerical solution of gas pressure (top) and gas flow velocity magnitude (bottom) for configuration depicted for the configuration shown in FIG. 1 at one particular operational point. Besides the gas pressure, the spatial distribution of the gas flow velocity magnitude 201 is of particular interest.

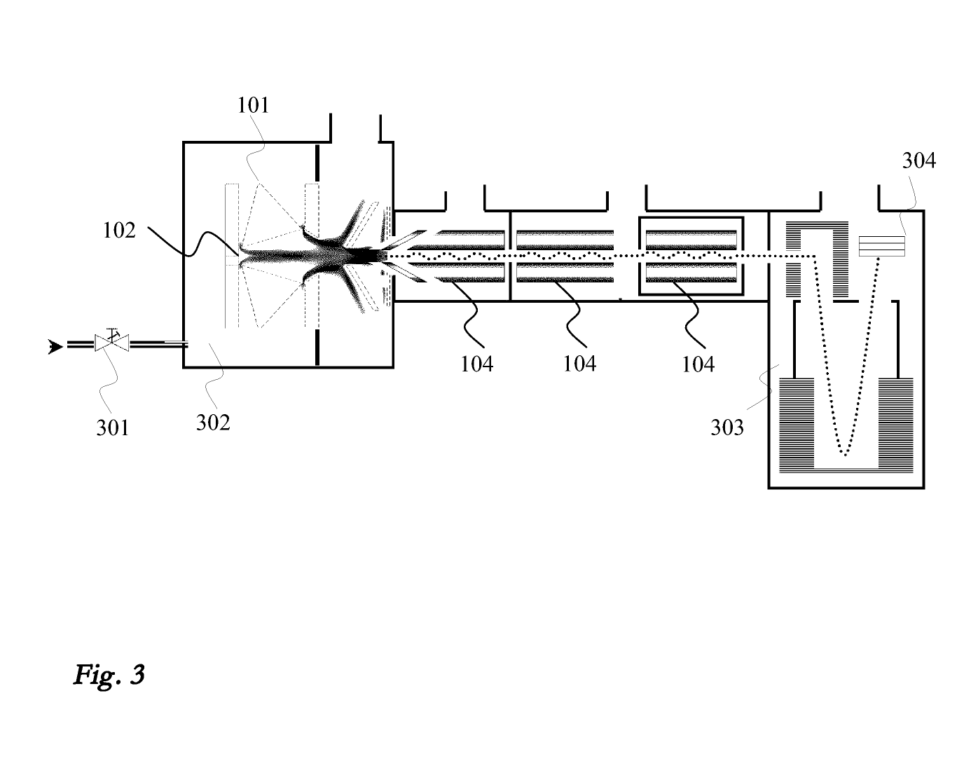

In practical applications, electro-pneumatic ion sources are contained in housings and connected to mass spectrometers. In some particular embodiments of the invention, as shown in the FIG. 3, the electro-pneumatic elements 101 are supplied with gas via a reservoir 302. The gas is supplied to the reservoir via one or more adjustable valves 301. FIG. 3 shows an ion source connected to a highend triple-quadrupole time-of-flight (TOF) instrument that contains a series of RF quadruples 104, a time-of-flight region 303, including ion detector 304.

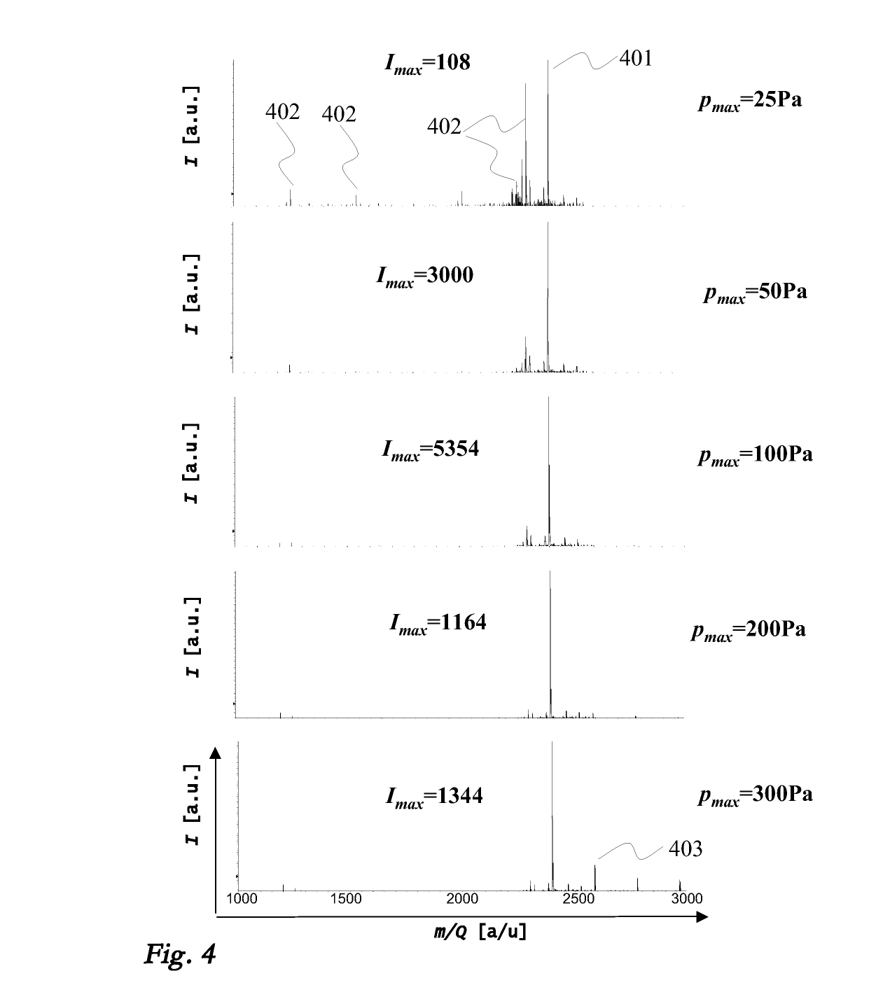

Mass spectra obtained with such configurations can exhibit many artifacts such as ion fragmentation, ion clustering, or insufficient ion transmission due to superposition breakdown if the ion source is not operating at optimal conditions. An example is shown in FIG. 4 that provides mass spectra obtained from a single labile compound at different reservoir pressures ρₘₐₓ of an electric-pneumatic LDI ion source. Since only a single compound is used the expected true signal is a single peak in the mass spectrum. Also indicated are the obtained intensities for the true peak 401 at m≈2398μ. At ρₘₐₓ=25 Pa substantial ion fragmentation occurs which results in numerous peaks 402 which do not represent the original composition of the sample. In addition, the total ion in intensity is a relatively low.

At ρₘₐₓ=100 Pa the maximum ion count for the true peak has been reached, however, ion fragments are still observed. The highest signal to noise ratio is reached at ρₘₐₓ=200 Pa although the total ion count is now reduced for this particular electro-pneumatic design. At ρₘₐₓ=300 Pa the signal to noise ratio decreases again due to the appearance of cluster ions 403. In addition to varying the reservoir pressure the electric potential on the electric-pneumatic elements thereby the electric field inside the ion source has to be modified in order to maintain sufficient ion transmission.

The actual optimal values for gas reservoir pressure and various electric potentials typically depend on the design of the electro-pneumatic elements, sample composition, surface chemistry of the chip as well as laser operation parameters in case of LDI. Further, it is apparent that the optimization can have different goals, such as improving the maximum ion count or the maximum signal to noise ratio.

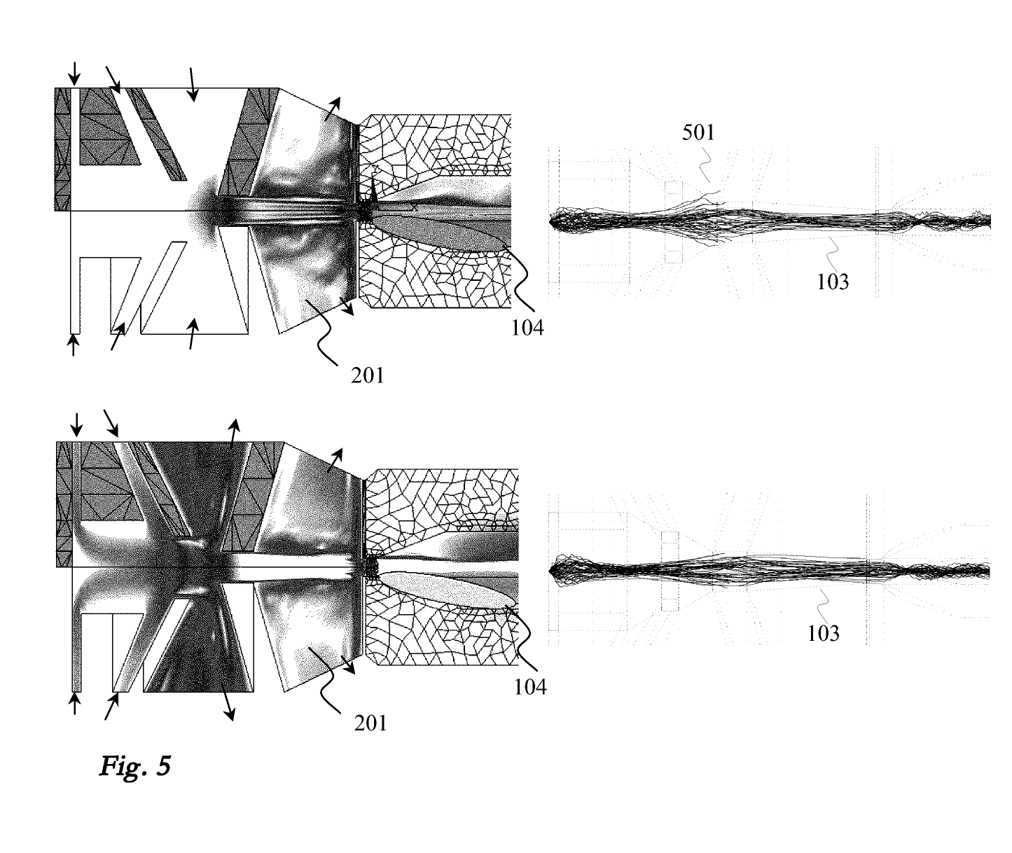

FIG. 5 illustrates an example, per embodiments of the invention, as to how variations in the gas supply may influence the spatial distribution of gas flow velocity magnitude 201 and thereby the guidance of ions and the total available ion high-end count. On the left side, the numerical solutions of the gas flow velocity magnitude are shown, and on the right side, the resulting ion trajectories for two operational points. At the top of FIG. 5 an electric-pneumatic configuration is supplied from the surrounding gas reservoir (not shown) through three of the four existing channels. The fourth channel is used to evacuate the gas from the system. At the bottom of FIG. 5 the same electro-pneumatic configuration is used, however, gas is supplied only through two of the four channels and evacuated via the remaining two. The configuration on top shows more ion losses 501.

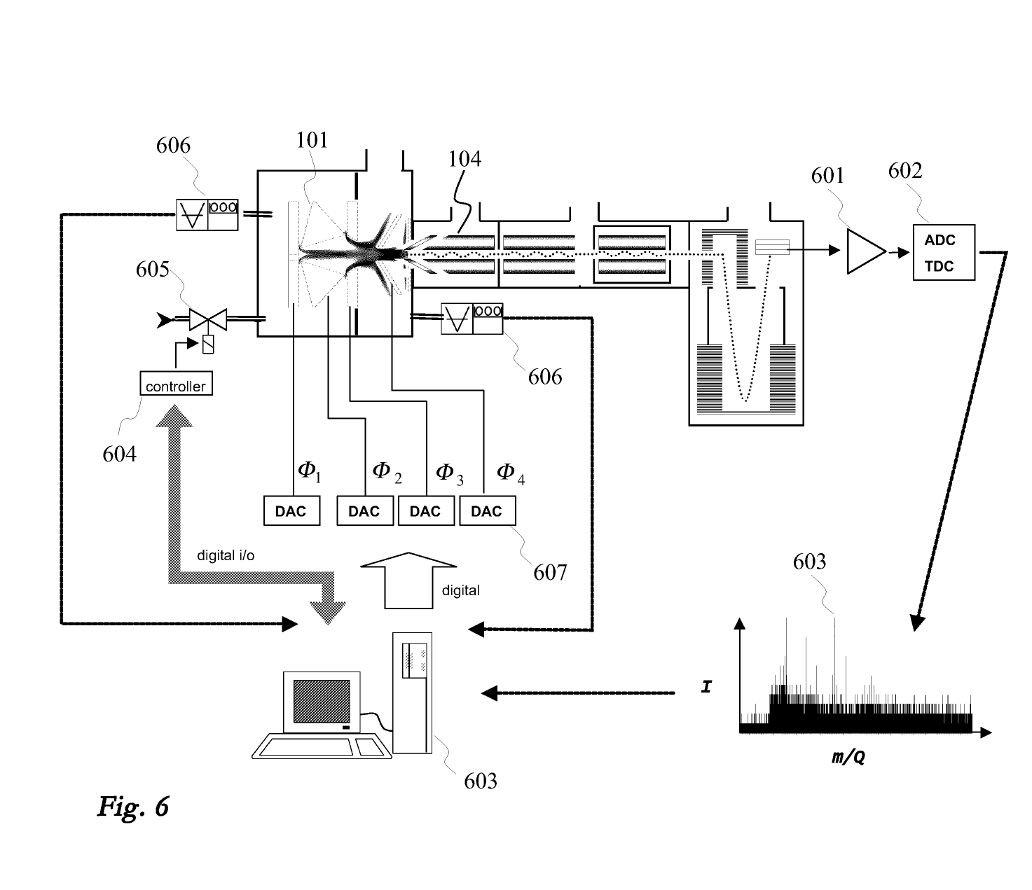

The aforementioned difficulties may be eliminated by implementing an active control and feedback system, per aspects of some embodiments, as shown in FIG. 6. The signal current from the ion detector is amplified 601 and digitized 602 to make the information contained in the mass spectrum processable by computer 603. According to aspects of the present invention, this computer (or one communicating with it) can also measure various operational conditions of the ion source and actively control and set parameters. For example, the variable gas inlet valve 605 may be driven, by a stepper motor or electromagnetically. The information required is provided to the valve controller by computer 603. Various pressure values that are, as a result, established inside the ion source are measured by digital pressure gauges which, in turn, provide these values to computer 603. In addition, computer 603 can set potentials φᵢ on the electro-pneumatic elements 101 via a plurality of digital to analog converters (DACs) 607.

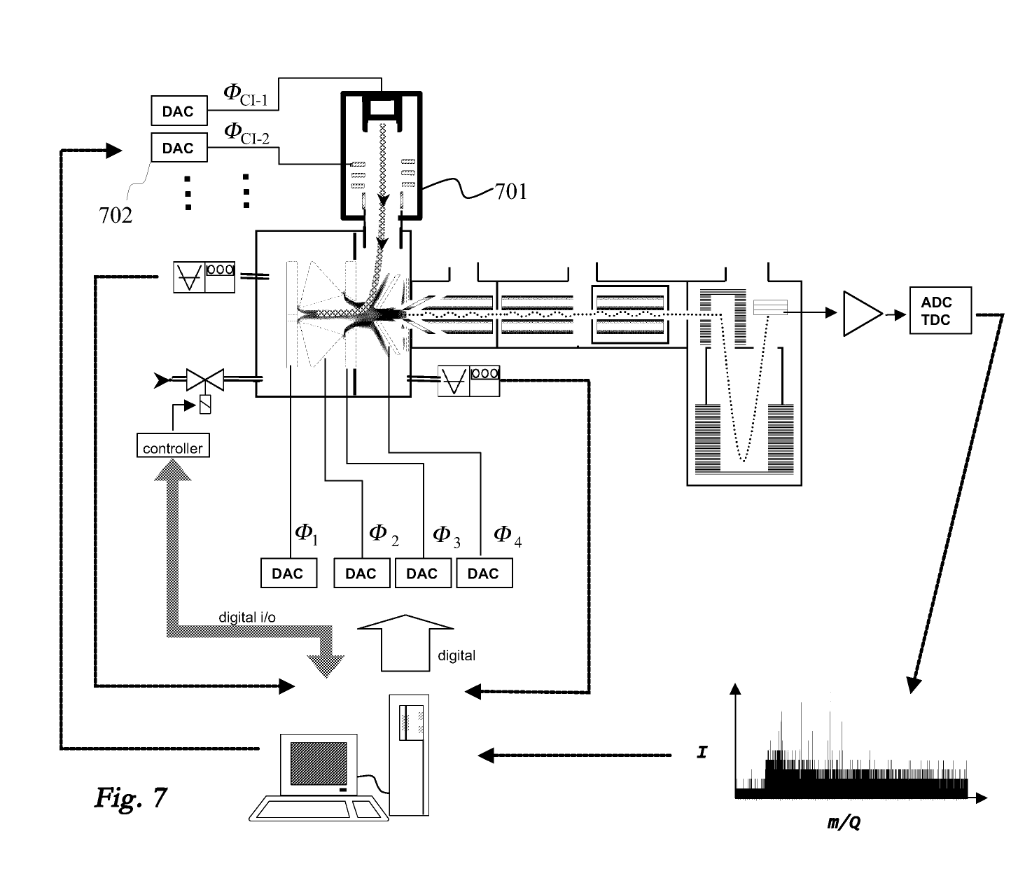

Another embodiment is shown in FIG. 7 wherein (in addition to the active feedback system for electric-pneumatic components) a charge-injection ion gun creating a CI-beam is used to increase the ionization efficiency of the LDI ion source as disclosed by above-referenced application of Hieke (U.S. App. No. 60/798,377, filed on May 5, 2006). The shown configuration will also require an additional magnetic field, orthogonal to the plane of the drawing. In some embodiments of the invention, the active control and feedback system may now also set values on the Charge-injection gun to optimize total system performance.

While particular embodiments of the invention and variations thereof have been described in detail, other modifications and methods of using the disclosed workflow management system will be apparent to those of skill in the art. Accordingly, it should be understood that various applications, modifications, and substitutions may be made of equivalents without departing from the spirit of the invention or the scope of the claims. Various terms have been used in the description to convey an understanding of the invention; it will be understood that the meaning of these various terms extends to common linguistic or grammatical variations or forms thereof. It will also be understood that when terminology referring, for example to physical equipment, hardware, or software has used trade names or common names, that these names are provided as contemporary examples, and the invention is not limited by such literal scope. Terminology that is introduced at a later date that may be reasonably understood as a derivative of a contemporary term or designating of a subset of objects embraced by a contemporary term will be understood as having been described by the now contemporary terminology. Further, it should be understood that the invention is not limited to the embodiments that have been set forth for purposes of exemplification, but is to be defined only by a fair reading of claims that will be appended, including the full range of equivalency to which each element thereof is entitled.

1. A method of optimizing control of electro-pneumatic ion-optical operation of an ion source utilizing electro-pneumatic superposition, the source being in ion communication with a mass spectrometer, the method using an active control system, the method comprising:
analyzing data generated during operation of the mass spectrometer, generating signals from the data analysis, and providing the signals as feedback to control the operation of the ion source.

2. The method of claim 1, wherein data comprise mass spectrum data from a sample.

3. The method of claim 1, wherein data comprise data from sensors reporting from the ion source.

4. The method of claim 1, wherein optimizing the control of the ion source comprises guiding ions.

5. The method of claim 1, wherein optimizing the control of the ion source comprises collisional cooling of ions.

6. The method of claim 1, wherein the ion source is a laser desorption ionization type.

7. The method of claim 1, wherein the ion source is an electrospray type.

8. The method of claim 1, wherein the ion source makes use of charge injection (CI-LDI/CI-MALDI).

9. The method of claim 1, wherein the ion source makes use of two-dimensional sample chips.

10. The method of claim 1, wherein optimizing control of the ion source is by changing the multiplicity of the gas reservoir pressures used to supply gas to the ion source region in which the electro-pneumatic superposition occurs.

11. The method of claim 1, wherein optimizing control of the ion source is by changing the total gas flow to the ion source region in which the electro-pneumatic superposition occurs.

12. The method of claim 1, wherein optimizing control of the ion source is by changing the electric potentials on electro-pneumatic elements.

13. The method of claim 1, wherein optimizing control of the ion source is by changing the mechanical arrangement of electro-pneumatic elements.

14. The method of claim 13, wherein changing the mechanical arrangement of electro-pneumatic elements comprises changing angles of the elements.

15. The method of claim 13, wherein changing the mechanical arrangement of electro-pneumatic elements comprises the use of active drives.

16. The method of claim 1, wherein optimizing control of the ion source is by changing the timing behavior of the electric-pneumatic parameters.

17. The method of claim 1, wherein optimizing control of the ion source is by changing the operation of a pump connected to the ion source.

18. The method of claim 1, wherein optimizing control of the ion source is by the use of throttling valve to change the gas flow to a pump connected to the ion source.

19. An active control system for optimizing control of electro-pneumatic ion-optical operation of an ion source utilizing electro-pneumatic superposition, the source being in ion communication with a mass spectrometer, the system comprising:
means for analyzing data generated during a sample-testing operation of the mass spectrometer,
means for generating signals from the data analysis, and
means for providing the signals as feedback control signals to the operation of the ion source.

20. The active control system of claim 19, wherein the system is integrated into the control system of the ion source.

21. The active control system of claim 19, wherein the system in integrated into the control system of the mass spectrometer.

22. The active control system of claim 19, wherein the system is a stand-alone device.

23. The active control system of claim 19, wherein the analyzed data are from the entirety of the mass spectrometric data operation.

24. The active control system of claim 19, wherein the analyzed data are from only during an initial phase of the mass spectrometric operation.

25. The active control system of claim 19, wherein the analyzed data are from a previous operation, the data having been stored.

26. The active control system of claim 19, wherein the system uses information encoded in a sample.

27. The active control system of claim 19, wherein the system uses information encoded on a bio-chip.

28. The active control system of claim 19, wherein the system uses an algorithm that derives the control signals provided to the ion source from data generated during operation of the mass spectrometer.

29. The active control system of claim 28, wherein the data from which the algorithm is derived include the total ion count.

30. The active control system of claim 28, wherein the data from which the algorithm is derived include the signal to noise ratio in the mass spectrum.

31. The active control system of claim 28, wherein the data from which the algorithm is derived include the amount of fragment or cluster ions in the mass spectrum.
